(19) United States
(12) Patent Application Publication
(10) Pub. No.: US 2022/0183454 A1
(43) Pub. Date: Jun. 16, 2022

(54) Truck Bed Liner Cleaning Tool

(71) Applicant: David Urbanowicz, Oviedo, FL (US)

(72) Inventor: David Urbanowicz, Oviedo, FL (US)

(21) Appl. No.: 17/530,657

(22) Filed: Nov. 19, 2021

Related U.S. Application Data
(60) Provisional application No. 63/125,645, filed on Dec. 15, 2020.

(51) Int. Cl. A46B 9/02; A46B 5/02; A46B 11/00; B60S 3/04

(52) U.S. Cl. CPC A46B 9/026; A46B 5/02; A46B 2200/3046; A46B 11/0072; B60S 3/044; A46B 11/001

(57) ABSTRACT

The present invention relates to a truck bed liner cleaning tool. The tool includes a long handle having an ergonomic grip detachably-secured to a brush head/cleaning frame. The brush head is configured in a wave/S-shape and has bristles disposed on the bottom. The bristles are arranged in a vertically raised and lowered form, forming an S-pattern to allow easy cleaning of the grooves of the bed liner. The brush head can have one or more storage cavities for storing cleaning solution, fresh water, etc. The bristles are designed to clean debris from the truck bed liner and prevent the bed liner from becoming stained, foul-smelling, discolored or deteriorated due to lack of cleaning.

### CROSS-REFERENCE TO RELATED APPLICATION

The present application claims priority to, and the benefit of, U.S. Provisional Application No. 63/125,645, which was filed on Dec. 15, 2020 and is incorporated herein by reference in its entirety.

### FIELD OF THE INVENTION

The present invention relates generally to the field of cleaning devices. More specifically, the present invention relates to a cleaning brush designed to assist truck owners or other users in cleaning the bed of their truck in a quick, easy and efficient manner. The truck bed cleaning brush tool comprises a long handle with a detachable bristle brush. The brush part is S-shaped and allows a user to clean within the grooves of their truck bed liner. The structure of the truck bed cleaning brush tool offers an easy method of cleaning a truck bed liner and preventing the liner from becoming stained, foul-smelling, discolored or deteriorated due to lack of cleaning. Accordingly, the present disclosure makes specific reference thereto. Nonetheless, it is to be appreciated that aspects of the present invention are also equally applicable to other like applications, devices and methods of manufacture.

### BACKGROUND

By way of background, truck owners transport a variety of items and materials in their truck bed, such as sod, dirt, rocks, etc. While transporting these items, material such as dirt, sod, etc., can get stuck to the bed liner, thereby making the truck bed dirty. The materials stuck to the bed liner surface may be difficult to remove using standard cleaning methods. Further, if the dirt and dust is retained on the bed liner for an extended period of time, the bed liner may become stained and discolored. Also, due to lack of proper cleaning, the bed liner may be foul-smelling.

Typically, conventional hoses are used for washing a truck bed, however, with standard hoses and other tools, the truck bed may not be properly cleaned. Tools such as a standard rake are also used for brushing dirt, dust, rocks, etc., off of the truck bed surface. However, use of a standard rake tool may not be efficient in cleaning the dirt and dust deposited on a truck bed.

Other cleaning tools such as a wiper, cleaning brush, etc., are also available for cleaning a truck bed surface. However, these conventional cleaning tools may fail to clean the deep grooves of the bed liner, thereby deteriorating the truck bed surface. Without a thorough cleaning, the bed liner can become discolored, foul-smelling, etc., thereby lowering the value of the truck. Users may become frustrated if the truck bed is not properly cleaned, even after using multiple cleaning tools.

Therefore, there exists a long felt need in the art for a tool that can be used for effectively cleaning a truck bed. There is also a long felt need in the art for a cleaning device that ensures that a truck bed liner is properly cleaned. Additionally, there is a long felt need in the art for a truck bed cleaning tool that allows truck owners to transport items and materials such as dust, dirt, sod, etc., without worrying about how to ensure proper cleaning of the truck bed surface. Moreover, there is a long felt need in the art for a truck bed cleaning tool that ensures that the grooves of the truck bed liner are properly cleaned and no dust/dirt/rock remains stuck on the bed liner. Further, there is a long felt need in the art for a truck bed cleaning tool that does not require users to utilize multiple tools for cleaning the truck bed surface. Furthermore, there is a long felt need in the art for a cleaning tool that prevents truck bed liners from being stained, dirty, discolored, foul-smelling, etc., due to dirt/dust deposited on the truck bed liner surface. Finally, there is a long felt need in the art for a truck bed cleaning tool that offers an easy method of cleaning the truck bed, and provides a method of maintaining the overall value of the truck.

The subject matter disclosed and claimed herein, in one embodiment thereof, comprises a truck bed liner cleaning tool that is designed for cleaning the bed of a truck in a quick, easy and effective manner. The cleaning tool of the present invention comprises an elongated handle, a brush head detachably-secured to the handle and bristles disposed on the bottom surface of the brush head. The bristles are designed in an S-shape or zig-zag shape, defining a plurality of a first set of bristles and a plurality of a second set of bristles, wherein each bristle of the first set of bristles is vertically raised and each bristle of the second set of bristles is vertically lowered, allowing the first set of bristles to clean the raised bedliner components and the second set of bristles to clean the grooves between the bedliner components. The cleaning tool can be used to clean any truck bedliner and enables a user to clean the grooves easily and effectively without having to bend over and get on the user's hands and knees, thereby minimizing the stress on a user's body during the cleaning process.

In this manner, the novel truck bed liner cleaning tool of the present invention accomplishes all of the forgoing objectives, and provides a relatively efficient, easy and convenient solution to cleaning a truck bed and ensuring that dust, dirt, rocks, etc., are not left behind on the truck liner after the cleaning. The truck bed liner cleaning tool of the present invention is also user-friendly, as it eliminates the need for multiple tools for properly cleaning the bed liner, and prevents frustration amongst users due to improper bed liner cleanings. The truck bed liner cleaning tool prevents dirt and/or dust from being deposited onto the truck bed liner, and therefore prevents the truck bed liner from becoming stained, discolored, foul-smelling, etc., and increases the value of the truck.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a truck bed liner cleaning tool. The truck bed liner cleaning tool is designed for cleaning the bed of a user's truck in a quick, easy and efficient manner. The cleaning tool comprises an elongated handle, a brush head detachably-secured to the handle and bristles disposed on the bottom surface of the brush head. The bristles are configured in an S-shape or zig-zag shape, and define a plurality of a first set of bristles and a plurality of a second set of bristles, wherein each bristle of the first set of bristles is vertically raised and each bristle of the second set of bristles is vertically lowered, allowing the first set of bristles to clean the raised bed liner components and the second set of bristles to clean the grooves between the bed liner components. More specifically, the cleaning tool can be utilized with any truck bed liner and enables a user to clean the grooves easily and effectively without having to bend over and get on the user's hands and knees, thereby minimizing the stress on a user's body during the cleaning process.

In yet another embodiment of the present invention, a truck bed liner cleaning device is disclosed. The cleaning device includes a wave-shaped brush head having raised portions and lowered portions, an elongated handle detachably-secured to the brush head, a plurality of a first set of bristles disposed on a bottom surface of said raised portions, and a plurality of a second set of bristles disposed on a bottom surface of said lowered portions, wherein the bottom ends of the first set of bristles are vertically above the bottom ends of the second set of bristles. In use, the plurality of the first set of bristles is positioned on the bedliner components and the plurality of the second set of bristles is positioned on the grooves between the bedliner components.

In yet another embodiment of the present invention, a truck bed cleaning device having a brush head and a handle connected to the brush head through a connector is disclosed. The handle has a top end including an ergonomic grip. The handle also has a bottom end to insert into a groove of the brush head. The brush head includes a first storage cavity that is operably connected to a conduit, which selectively releases a quantity of cleaning/soapy solution stored within the cavity onto the bristles. More specifically, the conduit extends from the first storage cavity to the bristles at the base of the brush head.

In yet another embodiment of the present invention, the brush head includes a second storage cavity that is operably-connected to a conduit which selectively releases a quantity of fresh water stored within the cavity onto the bristles. More specifically, the conduit extends from the second storage cavity to the bristles at the base of the brush head.

In yet another embodiment of the present invention, a novel arrangement of bristles disposed on a cleaning frame is disclosed. The arrangement includes a plurality of a first set of bristles and a plurality of a second set of bristles, each of the first set and the second set are alternatively positioned next to each other on the cleaning frame, wherein each bristle of the first set is vertically above each bristle of the second set, thus, forming an S-shape or zig-zag arrangement.

In yet another embodiment, a novel cleaning frame is disclosed. The cleaning frame is designed to attach to an elongated handle and have bristles for cleaning a surface. The cleaning frame has a wave-shape design, having alternate raised portions (crests) and lowered portions (troughs).

The advantage of the cleaning tool/device of the present invention is that it allows users to thoroughly and effectively clean their truck bed liner. The device also cleans the grooves of the truck bed liner. The device prevents the truck bed liner from becoming stained, foul-smelling, discolored, or deteriorated due to lack of cleaning.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the truck bed cleaning brush tool of the present invention in accordance with the disclosed architecture;

FIG. 2 illustrates a close-up view of the first set of bristles and the second set of bristles of one potential embodiment of the truck bed cleaning brush tool of the present invention and how the bed liner components and grooves between the bedliner components are cleaned in accordance with the disclosed architecture;

FIG. 3 illustrates a perspective view showing a user using one potential embodiment of the truck bed liner cleaning tool of the present invention in accordance with the disclosed architecture;

FIG. 4 illustrates a partial diagrammatic view of the bristles of one potential embodiment of the truck bed cleaning brush tool of the present invention, and showing the difference in height between the bottom ends of the first set of bristles and the bottom ends of the second set of bristles in accordance with the disclosed architecture;

FIG. 5 illustrates a perspective view of another potential embodiment of the truck bed liner cleaning tool of the present invention having solution storage cavities on the brush head in accordance with the disclosed architecture; and

FIG. 6 illustrates a perspective view showing the connection of the storage cavities disposed within one potential embodiment of the brush head of the truck bed liner cleaning tool of the present invention through conduits in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a tool that can be used for effectively cleaning a truck bed. There is also a long felt need in the art for a cleaning device that ensures that truck bed liners are properly cleaned. Additionally, there is a long felt need in the art for a truck bed cleaning tool that allows truck owners to transport items and materials such as dust, dirt, sod, etc., without worrying about how to ensure proper cleaning of the truck bed surface. Moreover, there is a long felt need in the art for a truck bed cleaning tool that ensures that the grooves of the truck bed liner are properly cleaned and that dust/dirt/rock do not remain stuck on the bed liner. Further, there is a long felt need in the art for a truck bed cleaning tool that does not require users to use multiple tools for cleaning the truck bed surface. Furthermore, there is a long felt need in the art for a cleaning tool that prevents truck bed liners from becoming stained, dirty, discolored, foul-smelling, etc., due to dirt and/or dust deposited on the truck bed liner surface. Finally, there is a long felt need in the art for a truck bed cleaning tool that offers an easy method of cleaning the truck bed and provides a method of maintaining the overall value of the truck.

The present invention, in one exemplary embodiment, is a novel truck bed liner cleaning tool that is designed to clean a truck bed in a quick, easy and efficient manner. The cleaning tool of the present invention comprises an elongated handle, a brush head detachably-secured to the handle, and bristles disposed on the bottom surface of the brush head. The bristles are configured in an S-shape or zig-zag shape, and define a plurality of a first set of bristles and a plurality of a second set of bristles. Further, each bristle of the first set of bristles is vertically raised and each bristle of the second set of bristles is vertically lowered, allowing the first set of bristles to clean the raised bed liner components, and the second set of bristles to clean the grooves between the bed liner components.

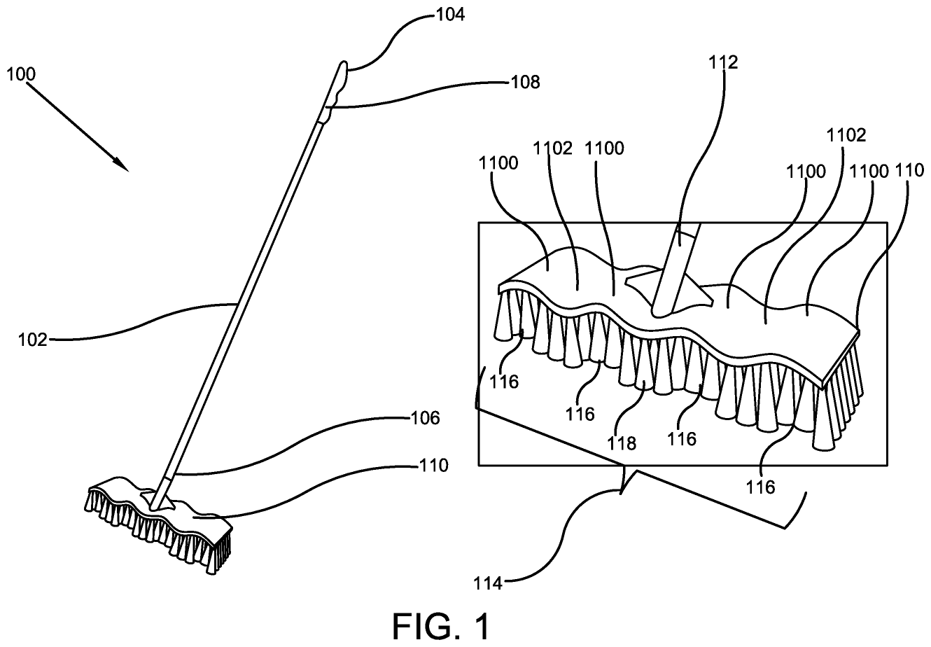

Referring initially to the drawings, FIG. 1 illustrates a perspective view of one embodiment of the truck bed cleaning brush tool of the present invention. The truck bed cleaning brush tool 100 of the present invention is designed to help truck owners and operators to effectively clean their truck bed in a quick, easy and effective manner. The cleaning brush tool 100 also prevents the bed liner from becoming stained, foul-smelling, discolored, or deteriorated due to lack of cleaning. Specifically, the cleaning brush tool 100 comprises a long and elongated cylindrical or tubular handle 102 that has a top end 104 and a bottom end 106. At the top end 104, the brush tool 100 has an ergonomic grip 108 which allows a user to comfortably and securely hold the tool 100 during the cleaning process. At the bottom end 106, the handle 102 is detachably-secured to a brush head 110. The brush head 110 is configured in a zig-zag or wave shape, and has a groove or boss 112 that extends vertically at an angle from the brush head 110. The groove or boss 112 has a diameter dimensioned and designed to receive the tubular handle 102, such that when the handle 102 is secured to the brush head 110, a portion of the handle 102 at the bottom end 106 is retained by the groove or boss 112. Thus, the handle 102 is secured to the brush head 110 via a press fit connection, a pin connection, etc., or any other suitable securing means as is known in the art.

The brush head/cleaning frame 110 comprises a plurality of bristles 114 on its bottom surface and along the length of the brush head 110. The bristles 114 extend downwards from the brush head 110. The advantage of the wave shape of the brush head 110 is that the bristles 114 are arranged in a S-shape which makes the cleaning tool 100 suitable for cleaning a truck bed that has equidistant liner components. As shown, the bristles 114 are divided in adjacent sets having a dissimilar vertical alignment. A first set of bristles 116 is positioned under the raised portion 1100 of the brush head 110, and is vertically higher than a second set of bristles 118 positioned under the lowered portion 1102 of the brush head 110, thus forming an S-shape or zig-zag design of the bristles 114. This S-shape design of the bristles 114 is advantageous, as it enables the bristles 114 to conform to the raised liner components and the grooves between the liner components.

In the present embodiment, the first set of bristles 116 and the second set of bristles 118 can have the same diameter. Alternatively, each bristle of the first set of bristles 116 can have a larger diameter than the diameter of each bristle of the second set of bristles 118. In use, the first set of bristles 116 makes sweeping contact with the bed liner components and the second set of bristles 118 makes sweeping contact with the grooves between the bed liner components. The bristles 114 are manufactured of a sturdy and durable material, such as chemically-resistant or chemical-proof material, (i.e., nylon, chamois leather, or polypropylene, etc.), or any other suitable material as is known in the art. Each bristle of the first set of bristles 116 can have a diameter in the range of approximately 0.010 inch-0.020 inch. Each bristle of the second set of bristles 118 can have a diameter in the range of approximately 0.008 inch-0.0015 inch.

The handle 102 can be available in different sizes and colors to accommodate the different needs and/or wants of a user. The exact size, measurement, construction and design specifications of the truck bed liner cleaning tool 100 may vary upon manufacturing or the particular material that is used. The handle 102 may be manufactured of a high tensile and durable metal such as aluminum, iron or an alloy such as steel, etc., or any other suitable material as is known in the art. The brush head 110 can be manufactured of industrial grade tough body plastics, thermoplastics, etc., or any other suitable material as is known in the art.

The handle 102 may be telescoping and available in different sizes and colors to accommodate a user's needs and/or wants, and the exact size, construction and design specifications of the cleaning tool 100 of the present invention may vary upon manufacturing. In one embodiment, the length of the handle 102 may be adjustable in size, from between three and six feet, with a telescopic structure that allows the length of the handle to be extended or shortened to suit a user's needs and/or wants. In the present embodiment, the length of the handle is fixed and is approximately five feet long.

The brush head 110 may be comprised of a relatively durable plastic or other suitable material as is known in the art, and may be rectangular, square, circular, etc., or any other suitable shape as is known in the art, and per a user's wants and/or needs. In the present embodiment, the brush head 110 may be approximately 24 inches wide and 3 inches high.

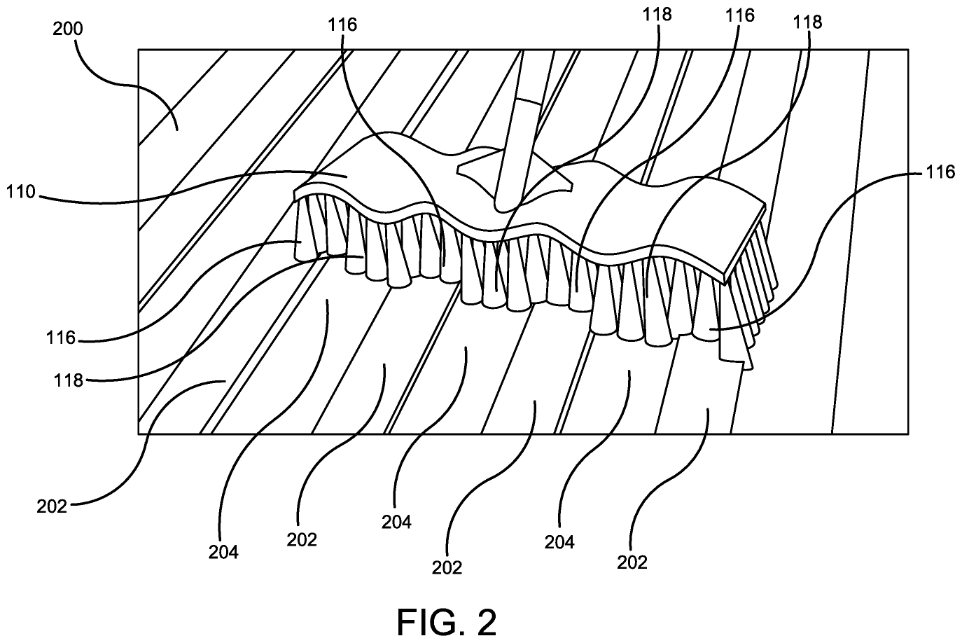

FIG. 2 illustrates a close-up view of the first set of bristles and the second set of bristles, showing how the bed liner components and grooves between the bed liner components are cleaned using the cleaning tool of the present invention. As stated supra, the novelty of the arrangement of the bristles is their S-shaped configuration. The bristles 114 are arranged in sets of different vertical orientations, thereby allowing the bed liner components and grooves between the bed liner components to be cleaned effectively. As shown in FIG. 2, the bedliner components 202 are slightly raised or protruded on the truck bed 200, thus creating grooves 204 between the bedliner components 202. In use, the vertically raised set or first set of bristles 116 is positioned on the bedliner components 202, and the vertically lowered set or second set of bristles 118 is positioned on the grooves 204 disposed between the bed liner components 202 for cleaning. This allows for uniform motion of the bristles 114 of the cleaning device 100 on the truck bedliners and provides an effective cleaning.

Bristles of both the first set 116 and the second set 118 of bristles have good shear and brake resistance and hard cleaning properties. The bristles 114 clean even hard stains without scuffing the bed liner material. Also, the brush head 110 can be detached and replaced with a new brush head when the bristles 114 are worn out after repeated use of the tool 100.

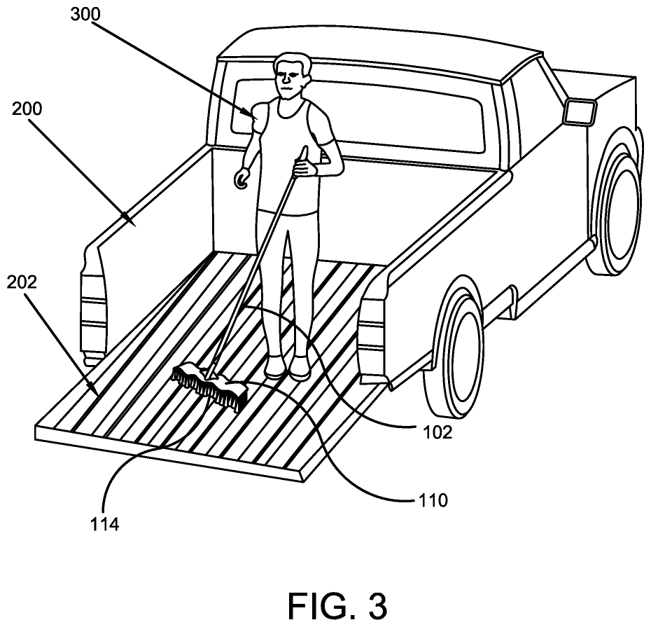

FIG. 3 illustrates a perspective view showing a user using one embodiment of the truck bed liner cleaning tool of the present invention. A user 300 such as a truck owner or operator can easily use the cleaning tool 100 by grasping the handle 102 and moving the bristles 114 on the bedliner 202 of the truck bed 200. It should be appreciated that the user 300 does not have to bend or sit for cleaning the bedliner 202, thus the truck bed liner cleaning tool can be easily used by users who are physically limited and/or have a limited range of motion. Further, the brush head 110 can be easily replaced with a new brush head when the bristles 114 are worn out.

In use, the bristles 114 (divided into a first set and a second set as described supra in FIGS. 1 and 2) come in contact with the bed liner components 202 and the grooves between the bed liner components 202 of a truck bed 200 as the user 300 pushes the cleaning tool 100 in a reciprocating manner. During use, debris and stains on the bed liner components 202 are agitated and/or expelled by the bristles 114. In practice, the brush head 110 is preferably pushed over the bed liner surface to agitate and/or expel a debris-laden cleaning solution that has been previously applied to accomplish chemical and/or mechanical cleaning.

The advantages of the cleaning tool 100 of the present invention can be seen with respect to the ability to have a thorough cleaning of the truck bed liner without having the user bend over and get on his or her hands and knees to scrub and clean the bed liner. The method employing the cleaning tool 100 of the present invention is important, since it provides a quick and easy solution to improve the cleaning of the bed liner, and prevents the bed liner from becoming stained, foul-smelling, discolored or deteriorated due to lack of cleaning.

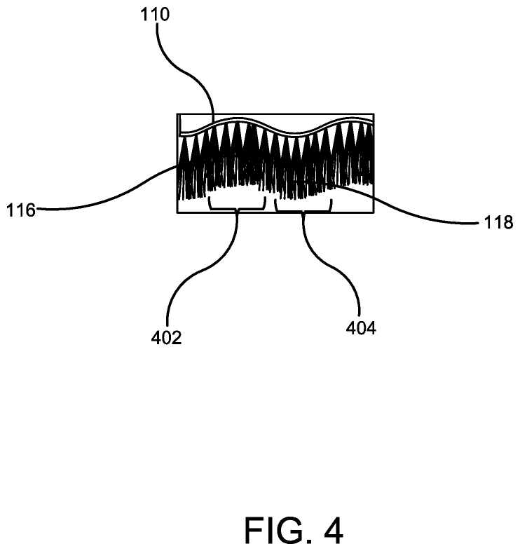

FIG. 4 illustrates a partial diagrammatic view of the bristles showing the difference in height between the bottom ends of the first set of bristles and the bottom ends of the second set of bristles. As the bed liner components of a truck bed are raised or protruded along their length and have grooves between them, the bristles of the cleaning tool of the present invention are designed and disposed such that the first set 116 of the bristles is designed to clean the bed liner components and the second set 118 is designed to clean the grooves. The bottom end 402 of the first set 116 is slightly longer in length than the bottom end 404 of the second set 118, such that their height difference is equal to the height of the bed liner components in conventional trucks. Thus, in use, the plurality of bristles do not break or lose their shape.

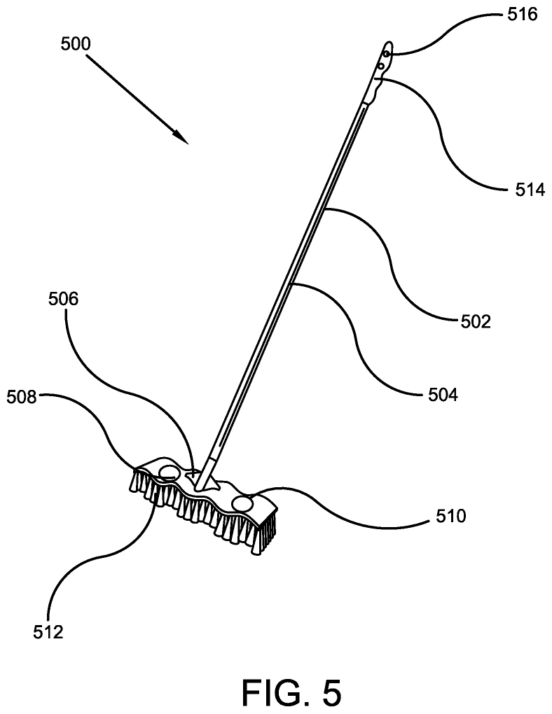

FIG. 5 illustrates a perspective view of another embodiment of the truck bed liner cleaning tool of the present invention having solution storage cavities on the brush head. In the present embodiment, the brush head 506 of the bed liner cleaning tool 500 provides effective cleaning and has a pair of small cavities 508, 510 for storing a soap solution and clean water, respectively. As shown, the first storage cavity 508 is on one side of the handle 502 and can be configured to store a soapy solution that is recessed though small openings of the brush head 506 through the bristles 512 to the truck bed surface. Similarly, a second storage cavity 510 can be configured to store fresh water for rinsing debris and dirt. The fresh water is also recessed through small openings of the brush head 506 through the bristles 512. The bristles 512 are oriented in a S-shape or zig-zag manner as described in FIG. 1 and FIG. 2. The bristles 512 are configured for both bed liner components and grooves between the bed liner components. Preferably, one or more controls 516 can be disposed near the grip 514 for controlling the flow of fluid from the storage cavities 508, 510. The controls 516 are connected to the storage cavities 508, 510 through a cable 504 running through the handle 502.

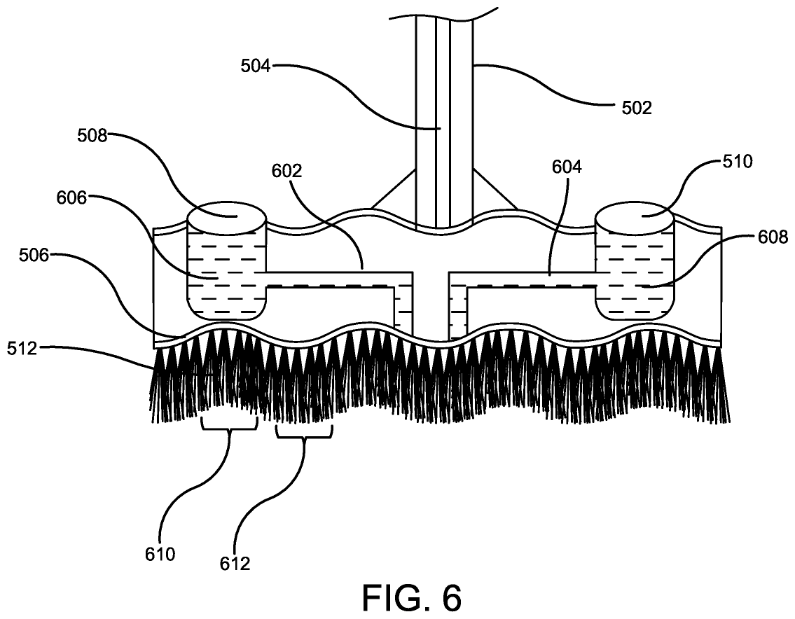

FIG. 6 illustrates a perspective view showing the connection of the storage cavities 508, 510 disposed within the brush head 506 through conduits 602, 604. The first storage cavity 508 stores a soapy solution 606, and is connected to the bristles 512 through a first conduit 602 to distribute the soapy solution 606 to the bristles 512. Similarly, the second storage cavity 510 stores fresh water 608 and is connected to the bristles 512 through a second conduit 604 to distribute the fresh water 608 to the bristles 512. The storage cavities 508, 510 can be selectively-operated by controls disposed on the handle 502 through the cable 504.

As in the other embodiments of the present invention, the bristles 512 are configured in an S-shape or zig-zag shape, having a difference in height as is shown between bottom ends 610 and 612 of the sets of bristles. The bristles 512 are designed for providing effective cleaning of both the bed liner components and the grooves between the bed liner components. It should be noted that the brush head 506 can be replaced with a new brush head as per the wants and/or needs of the users, and the storage cavities are covered by lids.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “truck bedliner cleaning tool”, “bedliner cleaning tool”, “cleaning tool”, “cleaning device”, and “device”, are interchangeable and refer to the truck bedliner cleaning tool 100, 500 of the present invention.

Notwithstanding the forgoing, the truck bed liner cleaning tool 100, 500 of the present invention can be of any suitable size and configuration as is known in the art without affecting the overall concept of the invention, provided that it accomplishes the above-stated objectives. One of ordinary skill in the art will appreciate that the size, configuration and material of the truck bed liner cleaning tool 100, 500 as shown in FIGS. 1-6 is for illustrative purposes only, and that many other sizes and shapes of the truck bed liner cleaning tool 100, 500 are well within the scope of the present disclosure. Although the dimensions of the truck bed liner cleaning tool 100, 500 are important design parameters for user convenience, the truck bed liner cleaning tool 100, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A truck bed cleaning brush tool configured to effectively clean a truck bed, the truck bed cleaning brush tool comprising:
a handle comprising a top end and a bottom end;
a brush head secured to the bottom end of the handle and configured in a wave or zig-zag shape;
wherein the brush head comprises a plurality of bristles on a bottom surface and along a length of the brush head;
wherein the plurality of bristles is divided into adjacent sets having a dissimilar vertical alignment; and
further wherein the wave or zig-zag shape of the brush head and the plurality of bristles enables the plurality of bristles to conform to raised liner components and grooves between the raised liner components of the truck bed.

2. The truck bed cleaning brush tool of claim 1, wherein the handle is an elongated cylindrical shape.

3. The truck bed cleaning brush tool of claim 2, wherein the handle comprises an ergonomic grip near the top end.

4. The truck bed cleaning brush tool of claim 3, wherein the brush head comprises a boss that extends vertically at an angle from the brush head.

5. The truck bed cleaning brush tool of claim 4, wherein the boss comprises a diameter dimensioned to receive the handle, such that when the handle is secured to the brush head, a portion of the handle is retained by the boss.

6. The truck bed cleaning brush tool of claim 5, wherein the plurality of bristles extends downwards from the brush head.

7. The truck bed cleaning brush tool of claim 6, wherein the plurality of bristles comprises a first set of bristles positioned under a raised portion of the brush head.

8. The truck bed cleaning brush tool of claim 7, wherein the plurality of bristles comprises a second set of bristles positioned under a lowered portion of the brush head.

9. The truck bed cleaning brush tool of claim 8, wherein the first set of bristles are longer in length than the second set of bristles, thus forming an S-shape or zig zag design of the plurality of bristles.

10. The truck bed cleaning brush tool of claim 9, wherein the first set of bristles and the second set of bristles have a same diameter.

11. The truck bed cleaning brush tool of claim 9, wherein each bristle of the first set of bristles has a larger diameter than a diameter of each bristle of the second set of bristles.

12. The truck bed cleaning brush tool of claim 11, wherein the first set of bristles are configured to clean the raised linear components of the truck bed.

13. The truck bed cleaning brush tool of claim 12, wherein the second set of bristles are configured to clean the grooves of the truck bed.

14. A truck bed cleaning brush tool configured to effectively clean a truck bed, the truck bed cleaning brush tool comprising:
a handle comprising a top end and a bottom end;
a brush head secured to the bottom end of the handle and configured in a wave or zig-zag shape having a raised portion and a lowered portion;
wherein the brush head comprises a plurality of bristles on a bottom surface and along a length of the brush head;
wherein the plurality of bristles is divided into a first set of bristles and a second set of bristles having a dissimilar vertical alignment;
wherein the first set of bristles are positioned under the raised portion of the brush head;
wherein the second set of bristles are positioned under the lowered portion of the brush head; and
further wherein the wave or zig-zag shape of the brush head and the plurality of bristles enables the first set of bristles to conform to and clean raised liner components of the truck bed and the second set of bristles to conform to and clean grooves between the raised liner components of the truck bed.

15. The truck bed cleaning brush tool of claim 14, wherein the first set of bristles and the second set of bristles have a same diameter.

16. The truck bed cleaning brush tool of claim 14, wherein each bristle of the first set of bristles has a larger diameter than diameter of each bristle of the second set of bristles.

17. The truck bed cleaning brush tool of claim 14 further comprising at least one storage cavity in the brush head for storing a soap solution or water.

18. The truck bed cleaning brush tool of claim 17, wherein the soap solution or water is recessed through small openings of the brush head through the plurality of bristles.

19. A truck bed cleaning brush tool configured to effectively clean a truck bed, the truck bed cleaning brush tool comprising:
a handle comprising a top end and a bottom end;
a brush head secured to the bottom end of the handle and configured in a wave or zig-zag shape having a raised portion and a lowered portion; and
wherein the brush head comprises a plurality of bristles on a bottom surface and along a length of the brush head and a pair of cavities for storing a soap solution and water on either side of the handle;
wherein the soap solution and water is recessed through small openings of the brush head through the plurality of bristles via a set of conduits disposed on the brush head;
wherein the plurality of bristles is divided into a first set of bristles and a second set of bristles having a dissimilar vertical alignment;
wherein the first set of bristles are positioned under the raised portion of the brush head;
wherein the second set of bristles are positioned under the lowered portion of the brush head; and
further wherein the wave or zig-zag shape of the brush head and the plurality of bristles enables the first set of bristles to conform to and clean raised liner components of the truck bed and the second set of bristles to conform to and clean grooves between the raised liner components of the truck bed.

20. The truck bed cleaning brush tool of claim 19 further comprising controls disposed on the handle for controlling flow of fluid from the pair of cavities through a cable.
